(19) United States
(12) Patent Application Publication
(10) Pub. No.: US 2025/0389587 A1
(43) Pub. Date: Dec. 25, 2025

(54) INFRARED TEMPERATURE SENSING SYSTEM

(71) Applicant: I-SHOU UNIVERSITY, Kaohsiung City (TW)

(72) Inventors: Rong-Ching WU, Kaohsiung City (TW); Hong-Wei XU, Pingtung County (TW); Tsai-Ting WU, Kaohsiung City (TW)

(21) Appl. No.: 18/942,808

(22) Filed: Nov. 11, 2024

(30) Foreign Application Priority Data
Jun. 21, 2024 (TW) 113123183

(51) Int. Cl. G01J 5/00; G01J 5/08; G01J 5/48; G06T 7/50

(52) U.S. Cl. CPC G01J 5/0025; G01J 5/0859; G01J 5/48; G06T 7/50; G01J 2005/0077; G06T 2207/10048; G06T 2207/30201

(57) ABSTRACT

An infrared temperature sensing system is provided to solve the problems of high cost and measurement errors of conventional infrared temperature sensing device. The infrared temperature sensing system includes two temperature sensing units, an infrared sensing unit, and a processing module. The two temperature sensing units measure a reference temperature and a reference room temperature, respectively. The infrared sensing unit detects the two temperature sensing units and acquires a first temperature measurement value corresponding to the reference temperature and a second temperature measurement value corresponding to the reference room temperature. The infrared sensing unit further detects a target to be measured and acquires a target temperature measurement value. The processing module calculates a target temperature value based on the reference temperature, the reference room temperature, the first and the second temperature measurement values, and the target temperature measurement value.

### CROSS REFERENCE TO RELATED APPLICATION

The application claims the benefit of Taiwan application serial No. 113123183, filed on Jun. 21, 2024, and the entire contents of which are incorporated herein by reference.

### BACKGROUND OF THE INVENTION

### 1. Field of the Invention

The present invention relates to a measurement and correction technology and, more particularly, to an infrared temperature sensing system that increases the accuracy of temperature measurement and reduces the costs of apparatuses.

### 2. Description of the Related Art

During an epidemic, to avoid a possible infectious individual from mingling into the crowd and spreading the disease, it is necessary to install contactless and wide-range temperature measuring instruments at the entrances and exits of public places to quickly screen out those with hyperthermia from the crowd. A conventional contactless temperature sensing device is an infrared thermograph, which is used to collect infrared radiation emitted from the surface of a target and having an energy that is proportional to temperature. By converting the radiation energy into an electric signal, temperature distribution of the detected target can be displayed according to the magnitude of the electric signal.

The functions and uses of the above-mentioned infrared temperature sensing device are limited by product specifications such as IR resolution and noise equivalent temperature difference (NETD). Simple thermographs that can measure temperatures with an error of ±5° C. are only suitable for displaying relative distribution of different temperatures in images, and therefore cannot accurately determine whether a human body temperature has reached an abnormal value. Advanced thermographs for medical use can reduce the measurement error to ±0.5° C., but require high-specification sensing elements and analysis modules, which render the thermographs expensive and difficult to be installed in large numbers in public areas. Thus, it is difficult to accurately detect and screen crowds of people coming from all directions. Moreover, infrared radiation will be absorbed by water, carbon dioxide, and other components in the atmosphere during propagation, which causes a reduction in the energy converted into the electric signal, leading to misjudgment. Furthermore, a background temperature in the environment will also interfere with the measurement accuracy of the sensing device on the target. Therefore, when the conventional infrared temperature sensing device is used in a large and busy public space, it is prone to misjudgment due to long sensing distance and mutual interference among multiple targets.

In view of this, it is necessary to improve the conventional infrared temperature sensing device.

### SUMMARY OF THE INVENTION

To solve the problems above, it is an objective of the present invention to provide an infrared temperature sensing system, which can increase temperature sensing accuracy.

It is another objective of the present invention to provide an infrared temperature sensing system, which can reduce apparatus costs.

It is yet another objective of the present invention to provide an infrared temperature sensing system, which can reduce computational burden and increase correction efficiency.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “engagement”, “coupling”, “assembly”, or similar terms is used to include separation of connected members without destroying the members after connection or inseparable connection of the members after connection. A person having ordinary skill in the art would be able to select according to desired demands in the material or assembly of the members to be connected.

An infrared temperature sensing system of the present invention includes two temperature sensing units, an infrared sensing unit, and a processing module. One of the two temperature sensing units is provided with a heating unit and measures a reference temperature. The other one of the two temperature sensing units measures a reference room temperature. The reference temperature is higher than the reference room temperature and a human body temperature. The infrared sensing unit detects the two temperature sensing units and acquires a first temperature measurement value corresponding to the reference temperature and a second temperature measurement value corresponding to the reference room temperature. The infrared sensing unit further detects a target to be measured and acquires a target temperature measurement value. The processing module is coupled to the two temperature sensing units and the infrared sensing unit. The processing module calculates a target temperature value by interpolation based on the reference temperature, the reference room temperature, the first temperature measurement value, the second temperature measurement value, and the target temperature measurement value.

Thus, the infrared temperature sensing system of the present invention uses the infrared sensing unit to detect the two temperature sensing units with known reference temperature and reference room temperature, and detects the target to be measured in a temperature range between the reference temperature and the reference room temperature. The infrared temperature sensing system is capable of correcting the target temperature value by interpolation to increase accuracy of temperature measurement of the infrared sensing unit, and has the effect of reducing apparatus costs, reducing measurement errors, and increasing efficiency of temperature correction.

In an example, the two temperature sensing units and the infrared sensing unit are received in a detection box, a sensing end of the infrared sensing unit is located at a bottom of a tapered notch on a surface of the detection box, and sensing ends of the two temperature sensing units are exposed outside an inner wall of the tapered notch, with a cross-sectional area of the tapered notch increasing from the bottom towards an opening of the tapered notch. Thus, the tapered notch can limit the direction of infrared sensing and set the two reference temperature points within the field of view of infrared sensing, providing the effect of reducing environmental interference and collecting corrected reference values.

In an example, the interpolation used by the processing module includes three relations R1=M1×w+b; R2=M2×w+b; and G=M3×w+b. R1 is the reference temperature, R2 is the reference room temperature, M1 is the first temperature measurement value, M2 is the second temperature measurement value, M3 is the target temperature measurement value, w is a correction weight, b is a correction deviation, and G is the target temperature value. Thus, values of the correction weight and the correction deviation can be calculated by using elimination by substitution to calculate the corrected target temperature value, providing the effect of increasing the sensing accuracy and reducing the computational burden of the processing module.

In an example, a distribution of corrected target temperature values generates a thermal image of the target to be measured, and the processing module estimates a measurement distance between the target to be measured and the infrared sensing unit based on a scale of the thermal image. Thus, the target can be identified and a temperature sensing range can be defined through the thermal image, providing the effect of avoiding misjudgment and reducing measurement errors.

In an example, the processing module establishes a relationship curve between a degree of temperature attenuation and the measurement distance. Thus, the relationship curve can be used to compensate for a distance attenuation error of the target temperature value, providing the effect of increasing accuracy of temperature sensing.

In an example, the processing module identifies a location of a face of the target to be measured based on the thermal image, and identifies whether the detected face is covered. Thus, the processing module can select a forehead or neck that is not covered, for instance, by mask or clothing to calculate a temperature value, and can also monitor the wearing of masks, providing the effect of increasing accuracy of temperature sensing and assisting in prevention of disease spreading in public places.

In an example, the processing module shields objects with large temperature variations other than the target to be measured. Thus, background objects with high or low temperature can be avoided from changing the brightness of the thermal image, providing the effect of reducing computing burden of the processing module and increasing accuracy of temperature sensing.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a block diagram of a preferred embodiment of the present invention.

FIG. 2 is a perspective view of a local structure of a preferred embodiment of the present invention.

FIG. 3 shows a detection field of view of an infrared sensing unit of a preferred embodiment of the present invention.

When the terms “up”, “down”, “top”, “bottom”, “inner”, “outer”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

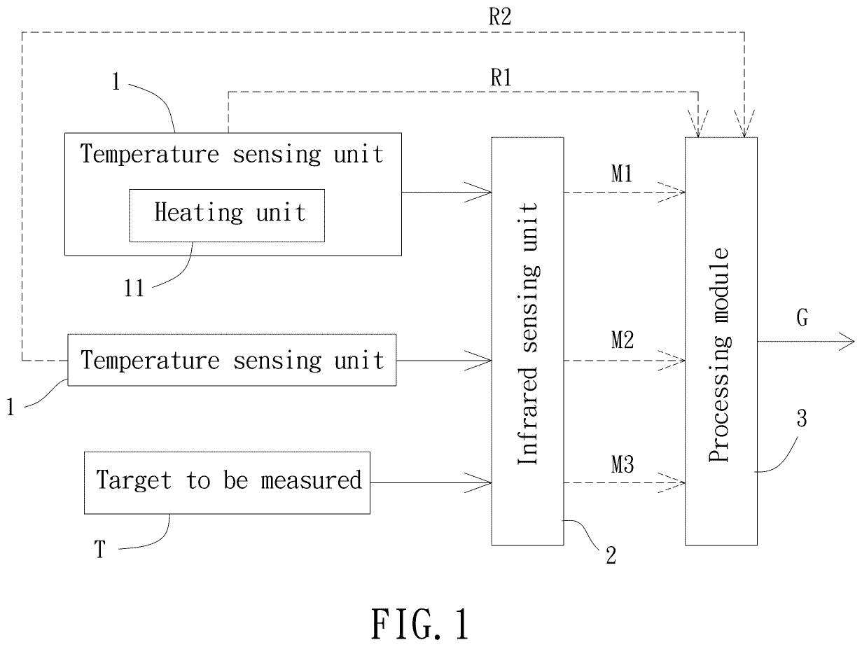

Referring to FIG. 1, a preferred embodiment of an infrared temperature sensing system of the present invention includes two temperature sensing units 1, an infrared sensing unit 2, and a processing module 3. The two temperature sensing units 1 and the infrared sensing unit 2 are coupled to the processing module 3. The infrared sensing unit 2 detects the locations of the two temperature sensing units 1 and a target T to be measured.

The two temperature sensing units 1 may be digital temperature sensors utilizing a thermistor effect. Resistance values of sensing elements of the two temperature sensing units 1 can increase as temperature rises, and the change in temperature can be converted into electric signals which are further converted by a microprocessor into corresponding temperatures and outputted in a digital form. The two temperature sensing units 1 are capable of generating temperature values of the surrounding environment or objects in close proximity. One of the temperature sensing units 1 is configured to measure the room temperature (about 20° C. to 30° C.), and the other temperature sensing unit 1 is provided with a heating unit 11. The heating unit 11 is set to heat up to a reference temperature R1. The reference temperature R1 is preferably higher than the room temperature and a human body temperature (e.g., 50° C.). In this way, the two temperature sensing units 1 obtain temperature values of the reference temperature R1 and a reference room temperature R2, respectively, and a range between the temperature values of the reference temperature R1 and the reference room temperature R2 can cover the human body temperature.

The infrared sensing unit 2 may be a thermograph camera, including an optical lens and a focal plane array (FPA) detector made of an infrared-sensitive material. Infrared radiation emitted from an object is focused on each pixel in the array through the optical lens to collect the infrared radiation energy with a wavelength of 8 μm to 14 μm and read a measured value of a number of pixels. That is, the higher the number of pixels, the higher the IR resolution of the infrared sensing unit 2, which is related to presenting details of temperature distribution. Moreover, the smaller the noise equivalent temperature difference of the infrared sensing unit 2, the less noise in the thermal image, which is related to reducing errors in the temperature measurement. The infrared sensing unit 2 detects the locations of the two temperature sensing units 1 and obtains a first temperature measurement value M1 corresponding to the reference temperature R1 and a second temperature measurement value M2 corresponding to the reference room temperature R2. The infrared sensing unit 2 can also detect a target T to be measured at the same time to obtain a target temperature measurement value M3.

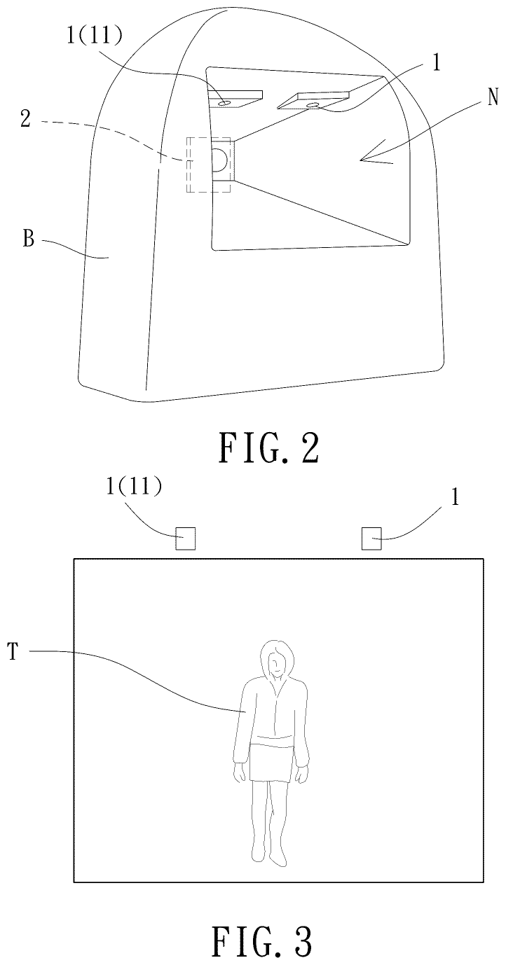

Referring to FIG. 2 and FIG. 3, the two temperature sensing units 1 and the infrared sensing unit 2 may be integrated in a detection box B. The detection box B has an accommodating space for receiving the two temperature sensing units 1, the infrared sensing unit 2 and signal lines thereof. Sensing ends of the two temperature sensing units 1 and the infrared sensing unit 2 are exposed outside the surfaces of the detection box B. The heating unit 11 is coupled to the sensing end of one of the temperature sensing units 1. One of the surfaces of the detection box B may have a tapered notch N. The area of the cross-section of the tapered notch N is gradually increasing from a bottom to an opening of the notch N. The sensing end of the infrared sensing unit 2 is preferably located at the bottom of the tapered notch N, which can limit the direction of infrared sensing to the opening of the tapered opening N, and has the effect of reducing the interference of the surrounding environment. Moreover, the sensing ends of the two temperature sensing units 1 are preferably exposed outside the inner wall of the tapered notch N. As shown in FIG. 3, which is an image field of view detected by the infrared sensing unit 2, when the target T to be measured is detected, the sensing ends of the two temperature sensing units 1 can be detected at the same time. However, the present invention is not limited to this structure.

Referring to FIG. 1, the processing module 3 can use hardware and software to process data to perform correction, image analysis, identification, etc. The processing module 3 may be a microcontroller, a server, a cloud platform, a desktop computer, a laptop, a tablet, etc. In this embodiment, the processing module 3 is a Raspberry Pi micro-single board computer with the advantages of low hardware cost, expandable software functions, and small size. It also has the features such as video output interface and wireless communication, which can transmit information, connect to databases, and present results of data processing, such as a body temperature monitoring screen, a hyperthermia alert, etc.

The processing module 3 receives the reference temperature R1, the reference room temperature R2, the first temperature measurement value M1, the second temperature measurement value M2, and the target temperature measurement value M3 from the two temperature sensing units 1 and the infrared sensing unit 2, respectively. The processing module 3 then calculates the corrected target temperature value G by interpolation, including using the following relations:

$$R 1 = M 1 \times w + b ; \qquad ( Relation 1 )$$

$$R 2 = M 2 \times w + b ; and \qquad ( Relation 2 )$$

$$G = M 3 \times w + b . \qquad ( Relation 3 )$$

In the above relations, w is a correction weight and b is a correction deviation. By substituting the reference temperature R1, the reference room temperature R2, the first temperature measurement value M1, and the second temperature measurement value M2 into Relation 1 and Relation 2, values of the correction weight w and the correction deviation b can be obtained. Then, by substituting the target temperature measurement value M3, the correction weight w, and the correction deviation b into Relation 3, the target temperature value G can be calculated.

In addition, the processing module 3 corrects the temperature measured by each pixel of the infrared sensing unit 2 and generates thermal images according to different temperature distributions. By using the image processing function, the processing module 3 can also identify the position and size of a face from the thermal image, detect a mask, and shield objects (e.g., a cold drink and a computer host) with large background temperature variations.

The processing module 3 can be configured to evaluate a measurement distance between the target T to be measured and the infrared sensing unit 2 by identifying the ratio of a fixed object area (e.g., the size of a face) of the thermal image of the target T to be measured to an overall width of the screen. Since the measurement distance will cause attenuation of infrared radiation energy, resulting in an error in the target temperature value G, the processing module 3 also needs to compensate the error of the target temperature value G with the measurement distance. Specifically, the processing module 3 can detect an object of known temperature through the infrared sensing unit 2, record measured temperature variations of a process of the measurement distance between the object and the infrared sensing unit 2 increasing from zero to seven meters, to establish a relationship curve between a degree of temperature attenuation and the distance. Then, the processing module 3 estimates the measurement distance and applies it to the relationship curve, which can compensate for the attenuation error of the target temperature value G. In this embodiment, the processing module 3 can measure the temperature of the target T to be measured at a measuring distance of seven meters and compensate for a distance error. However, accuracy of estimation decreases when the measuring distance goes beyond five meters, and the deviation of estimation of the measuring distance results in an error in the compensated target temperature value G. Therefore, a temperature detection range of the infrared sensing unit 2 of this embodiment is preferably from 1 meter to 5 meters.

The processing module 3 can measure the surface of a human body that is not covered by clothing, such as the forehead and the neck by identifying the position of a face in the thermal image, so as to increase accuracy of temperature measurement. Moreover, the processing module 3 can also identify whether the detected face is covered, for instance, with a mask through an image identification technique. Furthermore, the processing module 3 can also shield objects other than the face in the thermal image, especially objects with abnormally high or low temperatures. The high temperature objects will be the brightest area with highest energy in the thermal image, which will cause the overall thermal image to become relatively darker. In contrast, the low temperature objects cause the overall thermal image to become brighter and blurrier. Therefore, shielding the objects with large temperature variations can enhance the clarity of the thermal image, reduce the computational burden of the processing module 3, and increase the accuracy of temperature measurement of the target T to be measured.

In view of the foregoing, the infrared temperature sensing system of the present invention uses the infrared sensing unit to detect the two temperature sensing units with known reference temperature and reference room temperature, and detects the target to be measured in a temperature range between the reference temperature and the reference room temperature. The infrared temperature sensing system is capable of correcting the target temperature value by interpolation to increase accuracy of temperature measurement of the infrared sensing unit, and has the effect of reducing apparatus costs, reducing measurement errors, and increasing efficiency of temperature correction.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims.

What is claimed is:

1. An infrared temperature sensing system, comprising:
two temperature sensing units, wherein one of the two temperature sensing units is provided with a heating unit and measures a reference temperature, and the other of the two temperature sensing units measures a reference room temperature, wherein the reference temperature is higher than the reference room temperature and a human body temperature;
an infrared sensing unit, wherein the infrared sensing unit detects the two temperature sensing units and acquires a first temperature measurement value corresponding to the reference temperature and a second temperature measurement value corresponding to the reference room temperature, wherein the infrared sensing unit further detects a target to be measured and acquires a target temperature measurement value; and
a processing module coupled to the two temperature sensing units and the infrared sensing unit, wherein the processing module calculates a target temperature value by interpolation based on the reference temperature, the reference room temperature, the first temperature measurement value, the second temperature measurement value, and the target temperature measurement value.

2. The infrared temperature sensing system as claimed in claim 1, wherein the two temperature sensing units and the infrared sensing unit are received in a detection box, a sensing end of the infrared sensing unit is located at a bottom of a tapered notch on a surface of the detection box, and sensing ends of the two temperature sensing units are exposed outside an inner wall of the tapered notch, wherein a cross-sectional area of the tapered notch is increasing from the bottom towards an opening of the tapered notch.

3. The infrared temperature sensing system as claimed in claim 1, wherein the interpolation used by the processing module includes three relations
$$R 1 = M 1 \times w + b ;$$
$$R 2 = M 2 \times w + b ; and$$
$$G = M 3 \times w + b ,$$
wherein R1 is the reference temperature, R2 is the reference room temperature, M1 is the first temperature measurement value, M2 is the second temperature measurement value, M3 is the target temperature measurement value, w is a correction weight, b is a correction deviation, and G is the target temperature value.

4. The infrared temperature sensing system as claimed in claim 1, wherein a distribution of corrected target temperature values generates a thermal image of the target to be measured, and the processing module estimates a measurement distance between the target to be measured and the infrared sensing unit based on a scale of the thermal image.

5. The infrared temperature sensing system as claimed in claim 4, wherein the processing module establishes a relationship curve between a degree of temperature attenuation and the measurement distance.

6. The infrared temperature sensing system as claimed in claim 4, wherein the processing module identifies a location of a face of the target to be measured based on the thermal image, and identifies whether the detected face is covered.

7. The infrared temperature sensing system as claimed in claim 4, wherein the processing module shields objects with large temperature variations other than the target to be measured.
